(19) United States
(12) Patent Application Publication
(10) Pub. No.: US 2007/0032275 A1
(43) Pub. Date: Feb. 8, 2007

(54) Internal optical fiber hinge system for a consumer electronic device

(75) Inventors: Toshio Suzuki, Kawaguchi (JP); Gregory Bunin, Deerfield, IL (US)

Correspondence Address: PATZIK, FRANK & SAMOTNY LTD., 150 SOUTH WACKER DRIVE, SUITE 1500, CHICAGO, IL, 60606, US

(73) Assignees: Adamant Kogyo Co., Ltd.; Illum Technologies

(21) Appl. No.: 11/188,437

(22) Filed: Jul. 25, 2005

(51) Int. Cl. E05D 7/00; H01R 3/00; H04M 1/00

(52) U.S. Cl. 455/575.3; 16/221; 439/165

(57) ABSTRACT

A hinge system for a consumer electronic device such as a phone or camcorder comprising a hinge for: flipping portions of the device open or closed, sliding one portion of the device relative to another, and/or twisting one portion of the device relative to the other. The hinge system comprises either a flexible spring-like sheath or a plurality of rigid tubing members for permitting optical fiber to transmit information between corresponding light sources and detectors in the base and lid of the communications device. The hinge system may comprise any of the known types of hinges for use with an electronic communications device including a flip hinge, a flip-and-twist hinge and a sliding hinge.

### FIELD OF INVENTION

The invention relates generally to the field of consumer electronic communications and audiovisual equipment and, more particularly, to a hinge system enabling utilization of optical fibers for greater information transfer rates between the covers and the bases of such devices.

### BACKGROUND OF INVENTION

As of October of 2004, there were an estimated 170 million cellular telephone subscribers in the United States, with double digit growth annually. In addition to cellular telephones and pagers, other portable consumer electronic devices such as video or digital camcorders are also very popular. Because the video screens of the phones and camcorders, as well as the keypads or other controls are susceptible to being damaged, it is known to use a cover or lid that “flips” open about a hinge or slides along the plane of the screen to either reveal or hide the screen. To provide a variety of operable positions, many times the cover encompasses the screen and is capable of pivoting about a second axis usually perpendicular to the axis of rotation of the hinge. The use of a hinged lid also acts to decrease the overall size of the device, thereby making it more portable and appealing for consumers.

Currently, devices such as cell phones and camcorders usually use electrical flex circuits containing thirty or more copper wires attached together in a harness-like fashion to electrically connect the dial pad/base portions to the displays in such devices. With the ever-increasing need to transmit more data because of, among other things, higher resolution still and video cameras and camera phones, and greater bandwidth available for transmitting data and even video content to phones, conventional copper wires cannot transmit the necessary amount of information at the rate needed. Hence, the need arises to find systems and methods for increasing the capacity and speed of the connections and the information being transmitted.

While it is known that optical fibers can transmit the requisite amount of information at the desired rate, the operations of the flip hinges, which usually rotate about a substantially horizontal axis and the twisting lids or covers containing the screens that also rotate about a substantially vertical axis, currently make it difficult to insert the optic fiber needed to send more information faster. In particular, glass or plastic fiber can, among other things, break if it is bent too far during operation of the flip and/or twist lid, thereby destroying its ability to transmit information. Therefore, there is a need to produce a system for utilizing optical fiber to transfer data between the base and screen portions of a consumer electronic device such as a cellular or wireless phone or a camcorder containing a hinge assembly or system that enables the device to flip open or closed and/or twist around an axis that is substantially perpendicular thereto so as to overcome these problems.

The current invention accomplishes the ability to employ the benefits of greater data transfer rates of relatively fragile optic fiber in the environment of consumer electronic devices such as phone and camcorders that allow for flipping open of the base or keypad relative to the screen, about one axis of rotation—as well as twisting of the screen relative to the base about a second axis of rotation.

### SUMMARY OF INVENTION

The present invention is an improvement over the prior hinged consumer electronic devices such as a phone or a camcorder or a laptop computer in that the way that the hinged device utilizes optical fibers is unique and comprises an improvement over the prior art. One embodiment of the hinge system of the present invention for a cellular flip-type telephone comprises a plurality of substantially rigid tubing members that rotatably fit together in tight, telescopic fashion so as to permit the optical fiber to extend safely between the base and the lid of the cellular telephone. Although the figures and disclosures illustrate various embodiments of the invention in relation to a cellular telephone, the present invention may be applied to a variety of hinged communications and/or consumer electronic devices and is not limited to the specific types of products embodiments shown and disclosed therewithin.

A first embodiment of the hinge for a flip-type cellular telephone comprises a pair of substantially L-shaped substantially rigid tubing members that form a hollow conduit that extends between the base and the lid to permit an optical fiber to transmit information between respective paired light sources and detectors in the base and lid. This conduit can also serve as the hinge that permits the phone to be flipped open or closed. In particular, the first substantially L-shaped substantially rigid tubing member has a first or lower end that extends into the base and is affixed to the base by brackets, fasteners, gluing, molding or other known forms of affixation. A second end extends substantially along the horizontal flip axis of the phone. The second or upper substantially L-shaped substantially rigid tubing member has a first end that extends into the lid and is affixed thereto, and a second end that extends substantially along the horizontal flip axis and is affixed thereto. The second ends of the substantially rigid tubing members are sized so that one of the ends telescopically fits within the other end in such a way as to allow for rotational movement of the upper rigid tubing member relative to the lower tubing member when the lid is rotated or flipped between an open and closed position.

If the cellular telephone permits the lid to: (1) be flipped, and (2) twisted about a vertical axis relative to the flip axis, an alternate embodiment of the present invention comprises at least three substantially rigid tubing members that overlap and connect telescopically so as to permit rotation. The tubing members also act to form a conduit that extends between the base and the lid to permit an optical fiber placed therein to transmit information between respective light sources and detectors in the base and lid. In particular, the conduit comprises a first or lower substantially L-shaped substantially rigid tubing member that has a first end that extends into the base of the phone and is affixed thereto. A second end extends substantially along the horizontal flip axis. A second or central substantially L-shaped substantially rigid tubing member has a first end that extends substantially along the horizontal flip axis and a second end that extends substantially along the vertical flip or twist axis. An upper substantially rigid tubing member extends substantially along the vertical flip or twist axis. The ends of the central tubing member and the respective ends of the lower and upper tubing member are affixed, yet rotatable such that the central member may rotate about the lower tubing member when the lid of the phone is flipped open or closed, and the upper tubing member may rotate about the central tubing member when the lid is twisted about the vertical flip or twist axis. Hence, the conduit can serve as the hinge in such a device that not only carries and protects the optical fiber contained therein, but enables flip-like opening and closing of the lid relative to the base and twisting of the lid relative to the base

In yet another embodiment of the present invention, the optical fiber may extend through a hollow spring-like flexible sheath that extends between the base and the lid so that when the lid is pivoted between the open and closed position and/or twisted about the vertical axis, the sheath will likewise move or rotate without damaging the optic fiber contained therein. The sheath can be constructed like the thin tightly-coiled ribbon-like construction of the metal casing of a bicycle caliper brake cable assembly so as to provide a hollow central passage for the optic fiber to safely pass through the mechanical portion of the conventional hinge of the device. The optic Fiber is thus protected from excessive bending, yet the sheath does allow for some acceptable bending.

If the lid of the cellular telephone slides relative to the base into an open and closed position, a further embodiment of the hinge system of the present invention comprises a flexible spring-like sheath for surrounding the optical fiber, wherein the spring-like sheath preferably has an arcuate shape and is permitted to travel within a cavity in the base in substantially planar fashion as the lid is moved relative to the base.

Each of the embodiments disclosed may further comprise a plurality of paired light sources and detectors for permitting a plurality of optical fibers to transmit multiple types or sets of signals and information between the base and the lid in either direction. The hinge may also comprise an additional tubing member to allow electrical wires to supply power to the lid from the base or from the lid to the base.

Alternatively, if the existing hinges of the device provide for sufficient interior room so as to form an interior passageway, the optic fiber may be run from the base to the lid through that passageway, with or without any protective tube or sheath around the optic fiber.

It is therefore an object of the present invention to provide a new and improved system for consumer electronic devices that includes optic fiber capable of greater transmission rates.

A further object of the present invention is to provide a hinge system for consumer electronic devices that allows for the usage of fragile optical fibers to carry data at faster rates without breaking.

Yet another object of the present invention is to provide a hinge system that operably carries optic fibers therein in a sheltered fashion and enables both flipping open or closed of the base relative to the cover carrying the screen or touch pad, as well as twisting of the lid or cover relative to the base, without damaging the optic fibers contained therein.

Other objects, features and advantages of the invention will be apparent from the following detailed disclosure, taken in conjunction with the accompanying sheets of drawings, wherein like reference numerals refer to like parts.

### BRIEF DESCRIPTION OF DRAWINGS

The design of the system can be better understood by following the description of the drawings set forth herein. A brief description of each figure is included here.

FIG. 1 is a top plan view of a flip-hinge communications device of the present invention showing the tubing for permitting optical fibers to extend between the base and the lid.

FIG. 2 is an enlarged partial view of the hinged area of the flip-hinge communications device of FIG. 1.

FIG. 3 is a top plan view of a flip-and-twist hinge communications device of the present invention showing the tubing for permitting optical fibers to extend between the base and the lid.

FIG. 4 is an enlarged partial view of the hinged area of the flip-and-twist hinge communications device of FIG. 3.

FIG. 5 is a top plan view of another embodiment of a flip-hinge communications device of the present invention showing a spring-like sheath for permitting optical fibers to extend between the base and the lid.

FIG. 6 is an enlarged partial view of the hinged area of the flip-hinge communications device of FIG. 5.

FIG. 7 is a top plan view of another embodiment of a flip-and-twist hinge communications device of the present invention showing a spring-like sheath for permitting optical fibers to extend between the base and the lid.

FIG. 8 is an enlarged partial view of the hinged area of the flip-and-twist hinge communications device of FIG. 7.

FIG. 9 is a top plan view of a sliding hinge communications device of the present invention showing a spring-like sheath for permitting optical fibers to extend between the base and the lid.

FIG. 10 is an enlarged partial view of a section of the spring-like sheath of the sliding hinge communications device of FIG. 9.

FIG. 11 is a top plan view of a spring-like sheath of the present invention for use with multiple fibers, light sources and detectors.

### DETAILED DESCRIPTION OF DRAWINGS

While this invention is susceptible of embodiment in many different forms, there is shown in the drawings and will herein be described in detail several specific embodiments, with the understanding that the present disclosure is to be considered merely an exemplification of the principles of the invention and the application is limited only to the appended claims.

The present invention is directed toward a system for a consumer electronic device generally comprising a base and a lid that is hingedly attached to the base. While the figures and description disclose a flip, slide and/or twist-type portable or cellular telephone, it is appreciated the present invention may be utilized in any types of electronic communications devices utilizing a flip, slide and/or twist-type hinge structure such as, but not limited to camcorders, PDAs and tablets.

Referring to the figures, the hinged communications device of the present invention, generally designated by the number 10, is shown as having a base 12, a lid 14, a hinge assembly 16, 60 or 88, at least one optical fiber 18, and at least one light source 20 and paired detector 22 for transmitting and receiving light through and from the optical fiber 18. The device may or may not also comprise a hinge assembly of any of the known types of hinges for use with an electronic communications device including, but not limited to, a flip hinge 16, a flip-and-twist hinge 60 and a sliding hinge 88. The flip hinge 16 is a jointed device that enables the lid 14 to be opened, closed and, in certain devices, rotated or twisted by rotating the lid 14 about the flip hinge 16. Each of the hinges or the communications device preferably includes a stop (not shown) that prevents excessive lateral movement and/or rotation of the lid about the horizontal and vertical axes so as to prevent damage to the optic fiber contained therein.

In the case of a cellular telephone, it is appreciated that the lid preferably comprises a display screen 24 on its interior surface. Examples of a suitable display screen include, but are not limited to, a liquid crystal display (LCD). The cellular telephone 10 also comprises keypad 26, speaker 28 and a microphone 30 of the type generally known in the art.

While a variety of different materials such as glass may be used for the optical fibers (“GOF”) and not depart from the scope of the present invention, the preferred material is plastic optical fiber (“POF”) having a diameter of 250 microns. In particular, the optic fiber is preferably made of a plastic fiber with long pitch fiber that is slightly pre-twisted prior to installation. This pre-loading serves to minimize losses as the fiber will tend to straighten when the hinge is rotated. The POF can also be pre-coiled like a tight helical spring to maximize flexibility and prevent breakage. Similarly, while any of the known light sources for optical fibers may be used, the light source is preferably a VIXEL or a vertical cavity LED. The transfer rate of information through the hinge system of the present invention is ideally at least 1.3 gigabytes/second. The temperature ranges that the hinge system must be able to operate at are between 40 degrees Celsius to 85 degrees Celsius.

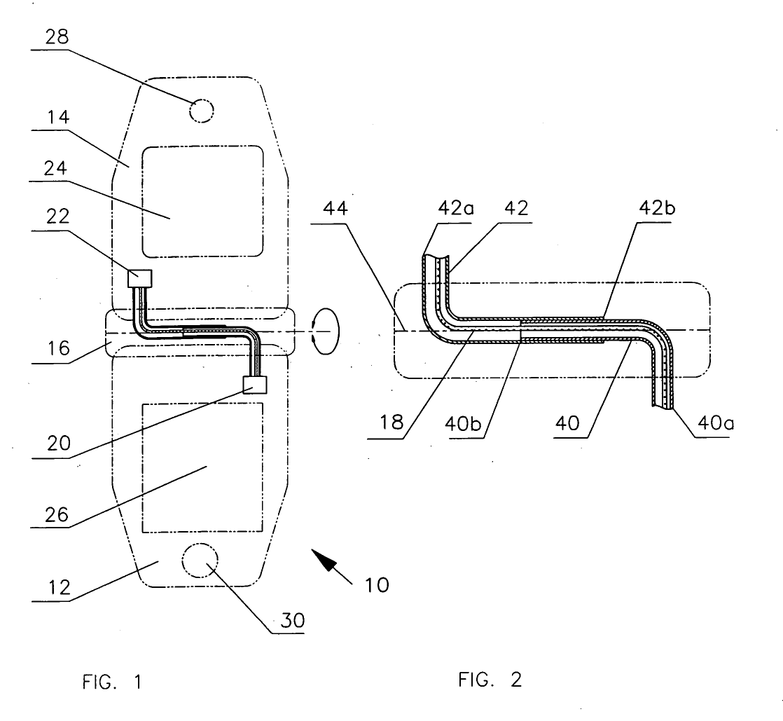

Referring to FIGS. 1 and 2, a first embodiment of a flip hinge of the present invention is shown for use with a flip hinge type cellular phone. The flip hinge 16 generally comprises a substantially L-shaped lower substantially rigid tubing member 40 having a first end 40a that extends into the base 12 and a second end 40b that preferably extends substantially along the flip axis 44; and a substantially L-shaped upper substantially rigid tubing member 42 that has a first end 42a that extends into the lid 14 and a second end 42b that extends substantially along the flip axis 44. The tubing thus provides a conduit for the optic fiber to pass between the base and the lid.

The diameter of the second end 40b of the lower tubing member 40 is preferably sized so that it is slightly less than the diameter of the second end 42b of the upper tubing member so that the second end 40b is telescoping received inside the second end 42b of the upper tubing member 42 and may rotate relative to the lower tubing member 40 when the lid 14 is pivoted between an open and a closed position. The difference in diameters between the second ends 40b & 42b of the tubing members 40 & 42 are such to protect the optical fiber 18 from contaminants and the like, while permitting the upper tubing member 42 to rotate relative to the lower tubing member 40. While the second end of the upper tubing member is shown as telescopically receiving the second end of the lower tubing member, it is appreciated that the lower tubing member may be sized to receive the upper tubing member. such that the second end of the upper tubing member rotates within the second end of the lower tubing member, and not depart from the scope of the present invention. The hinge system of the present invention can either serve as the hinge that enables the lid to flip open or closed with respect to the base, or the system work in conjunction with the conventional mechanical hinge provided in the device.

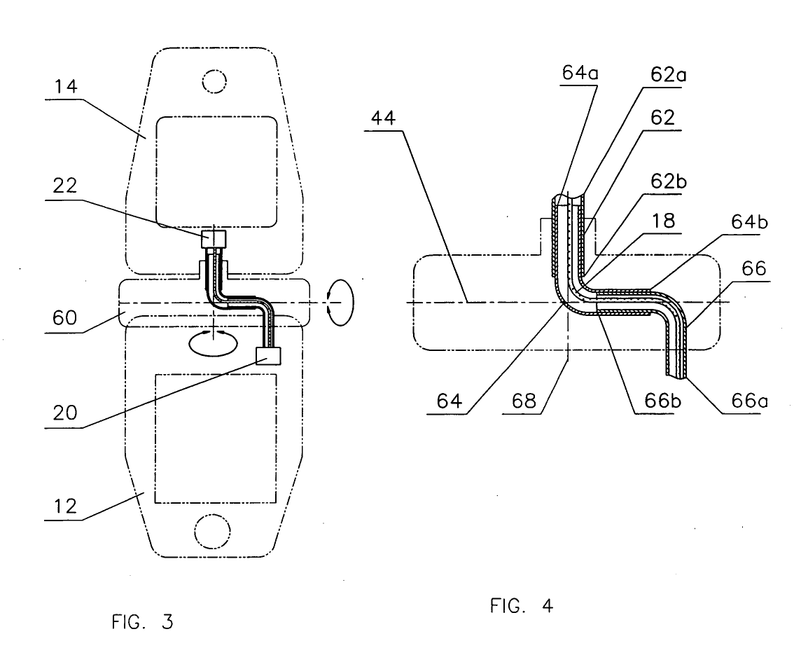

Referring now to FIGS. 3 and 4, an alternate embodiment of the flip hinge of the present invention is shown for use with a flip-and-twist type cellular telephone. The flip hinge 60 generally comprises a substantially L-shaped lower substantially rigid tubing member 66 having a first end 66a that extends into the base 12 and a second end 66b that preferably extends substantially along the horizontal flip axis 44; a substantially L-shaped central substantially rigid tubing member 64 having a first end 64a that extends substantially along the vertical twist axis 68 and a second end 64b that extends substantially along the horizontal flip axis 44; and a substantially straight upper substantially rigid tubing member 62 that has a first end 62a that extends into the lid 14 and a second end 62b that extends substantially along the vertical twist axis 68. The hinge system of the present invention can either serve as the hinge or hinges that enables the lid to flip open or closed and/or twist with respect to the base, or work in conjunction with the conventional mechanical hinge provided in the device.

In a preferred embodiment, the diameter of the lower and upper tubing members 62 and 66 are preferably sized so that they are slightly less than the diameter of the first and second ends of the central tubing member 64 so that the ends of the upper tubing member are telescopically received and may rotate relative to the central tubing member 64 about the vertical axis 68 and the lower tubing member 66 is telescopically received and may rotate relative to the central tubing member 64 about the horizontal axis when the lid 14 is pivoted between an open and a closed position. The difference in diameters between the ends of the tubing members are such to protect the optical fiber 18 from contaminants and the like, while permitting the lower and upper tubing members 62 & 66 to rotate relative to the central tubing member 64. While the central tubing member is shown as being received in the lower and upper tubing members, it is appreciated that the central tubing member may be sized to telescopically and rotatably receive the ends of the lower and upper tubing members and not depart from the scope of the present invention.

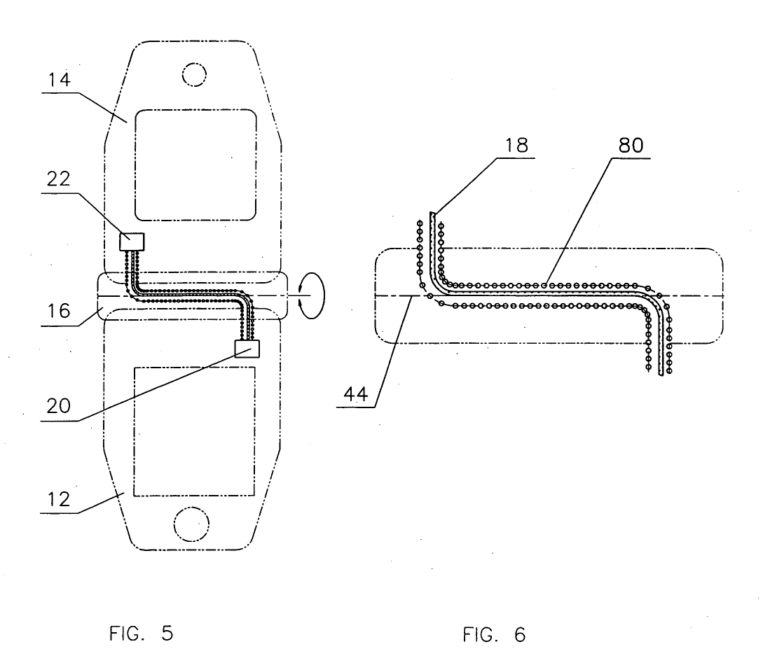

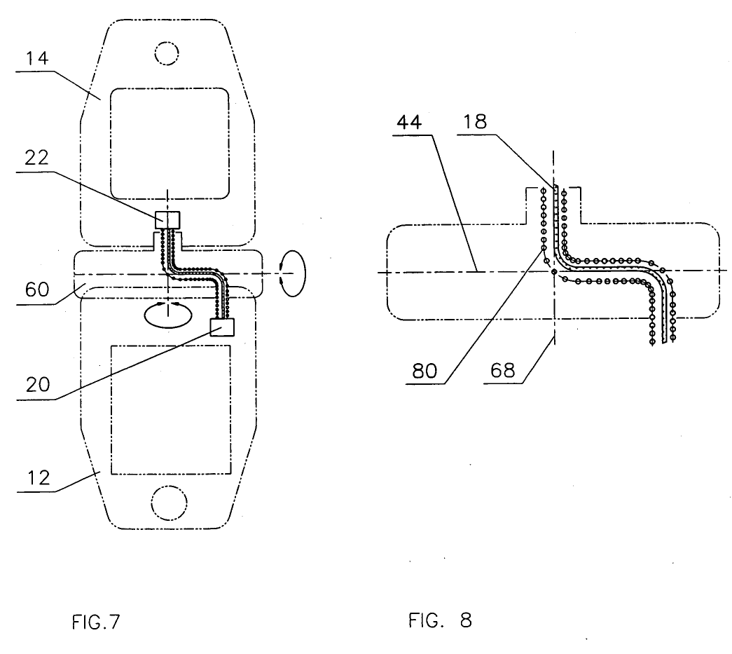

Referring now to FIGS. 5 through 8, it is appreciated that the optical fiber 18 may extend through a spring-like flexible sheath 80 rather than a plurality of substantially rigid tubing members and not depart from the scope of the present invention. The spring-like flexible sheath may be made of a thin coiled strip of metal or other known materials having elastic properties, so that when the lid is pivoted between the open and closed position and/or twisted about the vertical axis, in conjunction with the conventional horizontal or vertical mechanical hinges of the device, the sheath will be permitted to likewise move or rotate. In order to prevent breakage and high losses, the properties of the sheath preferably limit the radius of bending or movement of the sheath so as to keep the optic fiber in a safe range and prevent breakage thereof or excessive losses.

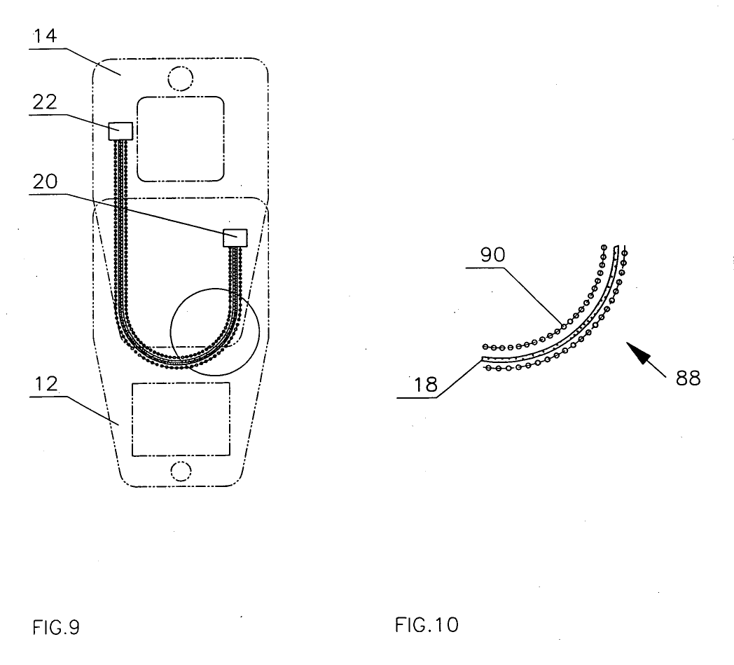

Referring now to FIGS. 9 and 10, an alternate embodiment of the hinge system of the present invention is shown for use with a sliding-lid type cellular telephone. The hinge 88 generally comprises a flexible spring-like sheath 90 surrounding the optical fiber 18. In one embodiment, the spring-like sheath 90 is arcuately-shaped to accommodate the substantially transverse movement of the sheath 90 in the base 12. In operation, the spring-like sheath 90 moves as needed within a cavity (not shown) within the base 12 as the lid 14 is slide between an open and closed position.

In an additional embodiment (not shown), the optic fiber can pass through an internal passage between the base and the lid in the existing conventional hinge present in the device with or without an outer sheath or tubing. Likewise, the spring-like sheath can pass between the lid and base by following the outer contour of the conventional hinge provided in the device.

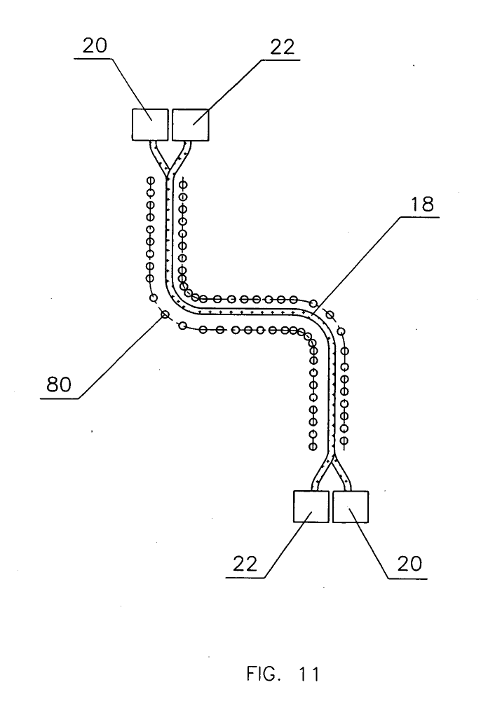

As shown in FIG. 11, it is appreciated that a plurality of paired light sources and detectors may be used with a plurality of optical fibers 18 extending between the lid 14 and the base 12 and not depart from the scope of the present invention. Furthermore, it is appreciated that a second sheath or tubing (not shown) may be used with the hinge system to carry power through electrical wires and/or serve as the negative or ground for the circuit.

Many modifications and variations of the present invention are possible in light of the above teachings. It is therefore to be understood that within the scope of the appended claims, the invention may be practiced otherwise than as specifically described. Various modifications, changes and variations may be made in the arrangement, operation and details of construction of the invention disclosed herein without departing from the spirit and scope of the invention. The present disclosure is intended to exemplify and not limit the invention.

1. A hinge system for a consumer electronics device having a base and a lid comprising:
at least one optical fiber extending between the lid and the base, the at least one optical fiber having a first end and a second end;
a light source operably located proximate the first end of the at least one optical fiber;
a detector operably located proximate the second end of the at least one optical fiber; and
a conduit for said optical fiber to pass from said base to the lid; and said conduit comprises a hinge enabling said lid to rotate relative to said base about a first axis of rotation.

2. The hinge system of claim 2 wherein said conduit further comprises a hinge enabling said lid to rotate relative to said base about a second axis substantially perpendicular to said first axis of rotation.

3. The hinge system of claim 1 wherein said conduit comprises rigid tubing having a hollow interior.

4. The hinge system of claim 1 wherein said conduit comprises a spring-like sheath having a hollow interior.

5. A hinged system for a consumer electronics device having a base and a lid, comprising:
a hinge connecting the base to the lid;
at least one optical fiber extending between the base and the lid, the at least one optical fiber having a first end and a second end;
a light source operably located proximate the first end of the at least one optical fiber;
a detector operably located proximate the second end of the at least one optical fiber; and
a protective and flexible spring-like sheath extending between the base and the lid for surrounding and protecting the at least one optical fiber.

6. The hinged system of claim 5 herein the device is a flip-type phone.

7. The hinge system of claim 5 wherein the device is a flip-and-twist-type phone.

8. The hinge system of claim 5 wherein the lid slides relative to the base.

9. The hinge system of claim 8 wherein the flexible spring-like sheath is at least substantially arcuate in shape.

10. The hinge system of claim 9 wherein the base comprises a cavity and wherein the spring-like sheath travels within the cavity as the lid is slid relative to the base into an open or a closed position.

11. The hinge system of claim 5 wherein the spring-like sheath comprises a coiled strip of metal.

12. The hinge system of claim 5 wherein the spring-like sheath comprises a central section that extends substantially parallel to said hinge.

13. The hinge system of claim 5 wherein the hinge defines a horizontal flip axis for rotating the lid relative to the base between an open and a closed position, and the spring-like sheath comprises a central section that extends substantially along the horizontal flip axis to permit the lid to be rotated relative to the base.

14. The hinge system of claim 13 wherein the lid defines a vertical twist axis extending therethrough, and the spring like sheath further comprises an upper section that extends substantially along the vertical twist axis to permit the lid to be twisted relative to the base.

15. A hinge system for a device having a base and a lid, comprising:
a hinge rotatably connecting the base to the lid, wherein the hinge defines a horizontal flip axis for rotating the lid relative to the base between an open and a closed position;
at least one optical fiber extending between the base and the lid, wherein the at least one optical fiber has a first end and a second end;
at least one light source located proximate the first end of the at least one optical fiber;
at least one detector located proximate the second end of the at least one optical fiber;
a first rigid tubing member having a first end extending into the base and a second end extending substantially along the horizontal flip axis; and
a second rigid tubing member having a first end extending into the lid and a second end extending substantially along the horizontal flip axis,
wherein the second end of the first rigid tubing member and the second end of the second rigid tubing member are rotatably joined so that the second rigid tubing member may rotate relative to the first rigid tubing member when the lid is rotated about the horizontal flip axis relative to the base.

16. The hinged communications device of claim 15 wherein the second rigid tubing member comprises:
a central rigid tubing member comprising a first end extending substantially along the horizontal flip axis and a second end extending substantially along a vertical twist axis extending into the lid, wherein the first end of the central rigid tubing member and the second end of the first rigid tubing member are rotatably joined, so that the central rigid tubing member may rotate relative to the first rigid tubing member when the lid is rotated about the horizontal flip axis relative to the base; and
an upper rigid tubing member comprising a first end extending substantially along the vertical twist axis and a second end extending into the lid, wherein the first end of the upper rigid tubing member and the second end of the central rigid tubing member are rotatably joined, so that the upper rigid tubing member may rotate relative to the central tubing member when the lid is twisted about the vertical twist axis.

17. The hinged communications device of claim 15 wherein the first and second rigid tubing members are substantially L-shaped.

18. The hinged communications device of claim 16 wherein the first and central rigid tubing members are substantially L-shaped.

19. A hinge system for a device having a base and a lid, comprising:
a hinge rotatably connecting the base to the lid, wherein the hinge defines a horizontal flip axis for rotating the lid relative to the base between an open and a closed position;
at least one stop for limiting the rotational movement of the lid relative to the base;
at least one optical fiber extending between the base and the lid, wherein the at least one optical fiber has a first end a second end;
at least one light source located proximate the first end of the at least one optical fiber;
at least one detector located proximate the second end of the at least one optical fiber;
a first substantially L-shaped rigid tubing member having a first end extending into the base and a second end extending substantially along the horizontal flip axis; and
a second substantially L-shaped rigid tubing member having a first end extending into the lid and a second end extending substantially along the horizontal flip axis,
wherein the second end of the first rigid tubing member and the second end of the second rigid tubing member are rotatably joined, so that the second rigid tubing member may rotate relative to the first rigid tubing member when the lid is rotated about the horizontal flip axis relative to the base.

20. The hinge system of claim 19 wherein the fiber comprises a plastic optic fiber with a slightly-twisted long pitch.

21. A flip-and-twist hinge system for a device having a base and a lid, comprising:
a said lid, defining a longitudinal twist axis for twisting the lid relative to the base;
a hinge connecting the base to the lid, wherein the hinge defines a horizontal flip axis for rotating the lid relative to the base between an open and a closed position;
at least one optical fiber extending between the base and the lid, wherein the at least one optical fiber has a first end and a second end;
at least one light source located proximate the first end of the at least one optical fiber;
at least one detector located proximate the second end of the at least one optical fiber;
a lower substantially L-shaped rigid tubing member having a first end extending into the base and a second end extending substantially along the horizontal flip axis; and
a central substantially L-shaped rigid tubing member comprising a first end extending substantially along the horizontal flip axis and a second end extending substantially along a vertical twist axis extending through the lid, wherein the first end of the central rigid tubing member and the second end of the first rigid tubing member overlap so that the central rigid tubing member may rotate relative to the first rigid tubing member when the lid is rotated about the horizontal flip axis relative to the base; and
an upper rigid tubing member comprising a first end extending substantially along the vertical twist axis and a second end extending into the lid, wherein the first end of the upper rigid tubing member and the second end of the central rigid tubing member are rotatably attached so that the upper rigid tubing member may rotate relative to the central tubing member when the lid is twisted about the vertical twist axis.

22. The flip-and-twist hinge communications device of claim 20 wherein the optic fiber comprises a plastic optical fiber with a slightly-twisted long pitch.

23. A hinge system for a device having a lid, a base and a hinge between the base and the lid, comprising:
said hinge having a central passageway spanning from said base to said lid;
at least one optical fiber having a first end and an opposite second end and extending between the base and the lid within said passageway of the hinge;
a light source located proximate the first end of the optical fiber; and
a detector, located proximate the second end of the optical fiber.

24. The hinge system of claim 23 wherein said system further comprises a conduit substantially surrounding said at least one optical fiber.

25. The hinge system of claim 24 wherein said conduit is a flexible spring-like sheath extending between the base and the lid.

26. The hinge system of claim 24 wherein said conduit is a rigid tubing extending between the base and the lid.
